(19) United States
(12) Patent Application Publication
(10) Pub. No.: US 2024/0326368 A1
(43) Pub. Date: Oct. 3, 2024

(54) Method of Manufacturing a Restrained Joint Gasket of Adjustable Length

(71) Applicant: S&B Technical Products, Inc., Fort Worth, TX (US)

(72) Inventor: Mark A. Weih, San Jose (CR)

(73) Assignee: S&B Technical Products, Inc., Fort Worth, TX (US)

(21) Appl. No.: 18/614,960

(22) Filed: Mar. 25, 2024

Related U.S. Application Data
(60) Provisional application No. 63/455,765, filed on Mar. 30, 2023.

(51) Int. Cl. B29D 99/00; B29C 69/00; B29K 705/00; B29L 31/26

(52) U.S. Cl. CPC B29D 99/0053; B29C 69/001; B29C 2793/0027; B29C 2793/0072; B29C 2793/009; B29K 2705/00; B29L 2031/265

(57) ABSTRACT

A method of manufacturing a sealing gasket is shown for use in a pipe sealing system. A pair of mating upper and lower mold plates are provided each having an exposed molding surface in the form of a spiral cavity. A length of pre-extruded elastomeric material in the shape of the near final form of the spiral mold cavity is laid into the mold cavities to substantially fill the cavities. The material may have hardened gripping elements incorporated therein. The upper and lower mold plates are closed to compress the elastomeric material within the spiral cavities and thereafter the material is cured to form a spiral strip. The spiral strip is then cut into given lengths having opposing free ends and the free ends are spliced to form completed sealing gaskets of a desired size.

### BACKGROUND OF THE INVENTION

### 1. Field of the Invention

The present invention relates generally to a method for molding relatively long and narrow elastomeric products of various lengths, and more particularly, to the field of pipe connections for sections of pipe such as those pipes used in the municipal water and sewer pipeline industries having such elastomeric components as sealing elements.

### 2. Description of the Prior Art

Pipes are commonly used for the conveyance of fluids under pressure, as in city water lines. They may also be used as free-flowing conduits running partly full, as in drains and sewers. Pipes for conveying water in appreciable quantities have been made of steel, cast iron, concrete, vitrified clay, and most recently, plastic including the various polyolefins and PVC. For example, Ductile Iron is a high strength, tough material which has traditionally been used in water and wastewater systems in the United States. Various types of plastic pipelines are also widely used.

While the instant invention will be described with reference to one form of the invention involving a metallic or ductile iron “coupling” or “fitting” being joined to a pipe which is a synthetic polyolefin, such as HDPE, the pipe being joined might also be made of other materials, such as a variety of plastics or polyolefins, including a polyethylene (HDPE), polyvinyl chloride (PVC), or any other pipe material commonly used in the industry. The principles of the invention may also be used in simple pipe “joints” as opposed to couplings or fittings. All of the types of pipeline materials will be referred to collectively as “pipe” in the discussion which follows.

In the typical waterworks installation, lengths of pipe are joined in telescoping relationship with the spigot end of one pipe being inserted into the socket end of the engaging pipe. The socket end has an opening large enough to receive the spigot end of the mating pipe. A gasket is typically present within the socket end of the pipe which is intended to prevent leakage of fluid from the joint by forming a seal between the two pipe sections at the pipe “joints.”

A primary concern in piping systems of the above type, whether in a straight run of pipe or at a coupling or fitting, is to provide adequate sealing at the pipe joints or couplings. In addition to the necessity of providing effective sealing, another important design requirement exists when it becomes necessary to join the pipe components in a “restrained” manner. This is usually desired in order to prevent the pipe components from separating due to thrust forces that often can occur when the pipeline is subjected to internal or external pressures, changes in direction or elevation of the pipeline, and sometimes when earthquakes or tremors or other external factors come into play.

In order to meet the need for a sealed and restrained joint of the above type, a number of companies in the industry have worked in recent years to develop various forms of restrained joint products. Some of these solutions have been provided of both the “push-on” type joints, as well as the traditional bolted mechanical joints.

Whether used in a sealing system only, or as part of a sealed and restrained system, the sealing gaskets used in the above described piping systems have often involved the use of a simple O-ring type rubber gasket. To provide adequate sealing, the cross section of such gaskets must be generally uniform whether it be round or some other shape. Also, the gaskets must have the proper length to match the particular size and type of pipe on which they are installed. For larger pipes, the length of the gasket material required is considerable, and also the variations in sizes and types of pipe are considerable. Accordingly, a large range of gasket sizes are required. This has, in the past, involved a great deal of expense, since providing a separate mold to make a gasket for each size required adds to expense. It was also necessary to warehouse a variety of gasket sizes. Another approach would be to form long lengths of gasket material of uniform cross section and then cut smaller portions to the proper length and splice the ends together when a particular gasket size was required.

The present invention has, as one object, to overcome certain of the previously described problems by providing a method for producing elongated gasket material of adjustable length, having the high degree of dimensional precision inherent in molded products, as well as an internal quality evidenced by uniform strength and appearance not usually obtained in the prior art extrusion methods.

Another object of the invention is to provide a method for producing a sealing and/or restrained gasket of the type described which can be formed from elastomer and plastic type materials not generally susceptible to being injection molded.

### BRIEF DESCRIPTION OF THE DRAWINGS

FIG. 1 is a perspective view of a prior art, commercially available metallic coupling of the type used to join sections of HDPE pipe, the coupling having sealing and restraint features.

FIG. 2 is a simplified, concept drawing of the bottom mold plate of a spiral mold of the type used in the practice of the invention.

FIG. 3A is a plan view of the upper surface of the bottom mold plate which is used in the practice of the invention.

FIG. 3B is a cross-sectional view taken along lines A-A in FIG. 3A.

FIGS. 4A and 5A are views similar to FIG. 3A of an alternative form of the lower and upper mold plates, respectively, that can be used in the practice of the invention.

FIG. 4B is a cross-section view taken through lines A-A in FIG. 4A.

FIG. 5B is a similar cross-section taken through lines B-B in FIG. 5A.

FIG. 6 is a partial cross-sectional view of the assembled top and bottom mold plates showing an injection gate for injecting elastomer material into the closed mold.

### SUMMARY OF THE INVENTION

As will be further described herein, a method is shown for manufacturing a sealing and/or restraining gasket for use in a pipeline sealing system. Mating upper and lower mold plates are provided, having top and bottom exposed mold surfaces, respectively. The exposed mold surfaces are provided in the form of a spiral groove or recess, the exposed surfaces registering to form a mold cavity shaped as a spiral coil of an elongated shape having a predetermined cross section when the mold halves are closed.

In one aspect of the invention, a length of pre-extruded elastomeric material is provided in the shape of the near final form of the spiral mold cavity. This pre-extruded material is laid into the 11 lower mold cavity to substantially fill the cavity. The upper and lower mold plates are then closed to compress the elastomeric material within the spiral cavities. The elastomeric material is then cured to form a spiral strip.

The spiral strip can then be removed from the mold and trimmed of any flashing, if necessary. The material is then cut into given lengths having opposing free ends. The free ends are then spliced together to form a completed sealing gasket of a desired diameter.

The pre-extruded elastomeric material which is used can assume a variety of shapes, for example, a simple O-ring of uniform cross-sectional diameter, or a more complex shape including, for example, a flat spiral where the spiral spreads radially in the mold cavity, a cylindrical helicoid/helical shape where the spiral extends axially like a corkscrew, and a conical hybrid, helical/spiral where the spiral extends axially and radially, or other complex shapes. The method of the invention has been used to produce a continuous spiral of gasket material is up to 50 feet or longer in length before being cut.

In this first aspect of the invention, the elastomeric material is uncured or only partially cured and is placed into the lower mold cavity, as laying the material in by hand. This also allows for the possibility of incorporating hardened gripping elements along the length of the uncured material.

Alternatively, the gripping elements may be incorporated into a length of gasket material and cured in place of otherwise affixed to the elastomer, as by gluing or the like.

In another aspect of the invention, one of the mold plates is provided with an injection gate and the elastomeric material is injected into the mold cavities after the mold halves are closed. A quantity of uncured elastomeric material is injected through the gate provided in the mold plates and into the spiral cavity to substantially fill the mold cavity between the upper and lower mold plate to form a complete spiral of elastomeric material. The mold plates are then held together for a time and for a temperature sufficient to cure the uncured elastomeric material. The spiral-shaped elastomeric material so formed is then removed from the mold and trimmed of any excess flash material. As previously described, the spiral shaped material can then be cut to desired lengths, each of the lengths having two free ends. The free ends can then be spliced to thereby produce a completed sealing gasket.

In another aspect of the invention, a “restrained” type sealing gasket is produced. The same type of upper and lower mating mold plates are provided, having upper and lower exposed mold 16 surfaces, respectively, the exposed mold surfaces being in the form of a spiral cavity. The exposed surfaces register to form a mold cavity shaped as a spiral coil of an elongated shape having a predetermined cross section when he mold halves are closed.

A length of partially or fully cured elastomeric material is placed into the spiral cavity of the lower mold plate, the elastomeric material having a series of discrete hardened gripping elements incorporated into the elastomeric material at spaced intervals along the length of the elastomeric material. The upper and lower mold plates are then brought together to thereby enclose the elastomeric material into a spiral mold chamber formed between the two mold plates. The elastomeric material is forced to substantially fill the spiral cavity formed between the exposed surfaces of the mold plates.

The mold plates are again held together at a desired temperature for a desired time to fully cure the elastomeric material containing the hardened gripping elements. The cured material can again be removed, cut to length and spliced to form individual scaling and restraining gaskets. The hardened gripping elements that are used may be made of metal or a hardened plastic material.

Additional objects, features and advantages will be apparent in the written description which follows.

### DETAILED DESCRIPTION OF THE INVENTION

The present invention provides a product and process which meet the foregoing described objectives. The invention described herein and the various features and advantageous details thereof are explained more fully with reference to the non-limiting examples which are illustrated in the accompanying drawing and detailed in the following description. Descriptions of well-known components and processes and manufacturing techniques are omitted so as to not unnecessarily obscure the workings of the invention. The examples used herein are intended merely to facilitate an understanding of ways in which the invention herein may be practiced and to further enable those of skill in the art to practice the invention. Accordingly, the examples should not be construed as limiting the scope of the claimed invention.

As briefly described, the present invention provides an improved molding method for molding relatively long and narrow elastomeric products of various lengths. The method is well suited for producing sealing gaskets of the type used in pipe connections for sections of pipe such as those pipes used in the municipal water and sewer pipeline industries having such elastomeric components as sealing elements. The invention has particular application to a combination sealing and restraint system with such elastomeric elements for use in metallic and ductile iron pipeline systems, as well as with plastic pipes used in PVC and HDPE pipeline systems, or with hybrid systems.

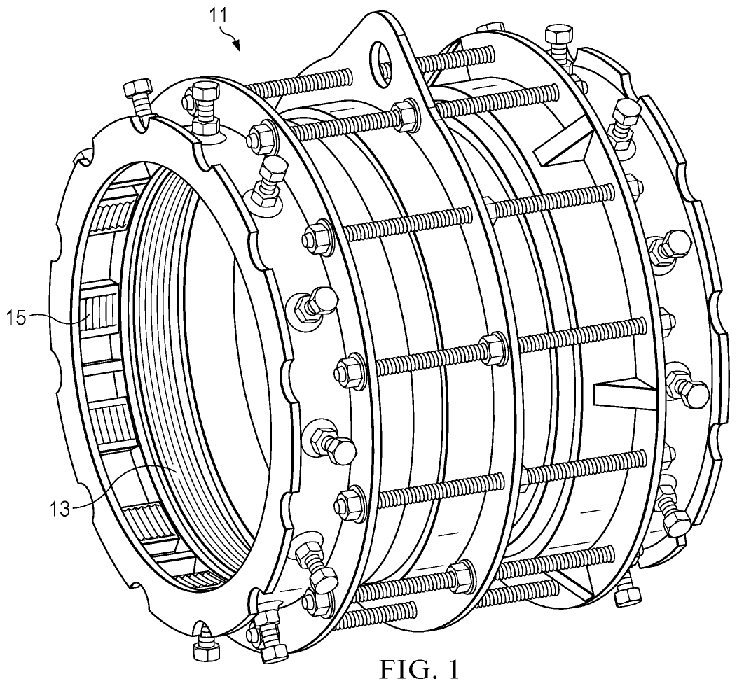

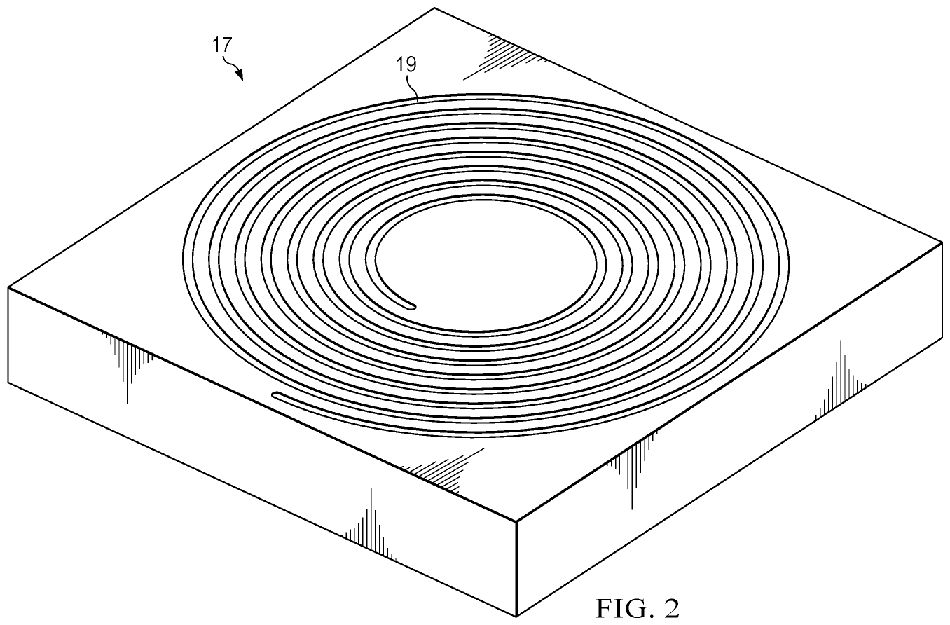

FIG. 1 shows a prior art, commercially available coupling, designated as 11, used in the waterworks industry to join sections of HDPE pipe to form a continuous pipeline. The particular coupling 11 has a center sleeve region and opposing end ring regions which are formed of carbon steel, per ASTM A36 or CSA 44W, the coupling being coated with an epoxy finish. Each of the opposing mouth or end openings of the coupling has an internal circumferential groove which contains a sealing gasket 13 which, in this case, is formed of nitrile (NBR) rubber per ASTM D2000. A separate circumferential groove contains a series of spaced hardened gripping elements or “teeth” (such as tooth 15), which are typically formed of metal. The method of the invention can be used to manufacture a sealing gasket which would replace the gasket 13 and which could also have integral gripping elements incorporated into the gasket itself, rather than having a separate ring of gripping elements, as shown at 15 in FIG. 1.

The method of the invention uses spiral molding technology as an integral part of the process. FIG. is a simplified concept drawing of a bottom mold plate 17 having a spiral groove pattern 19 formed in a top exposed surface thereof.

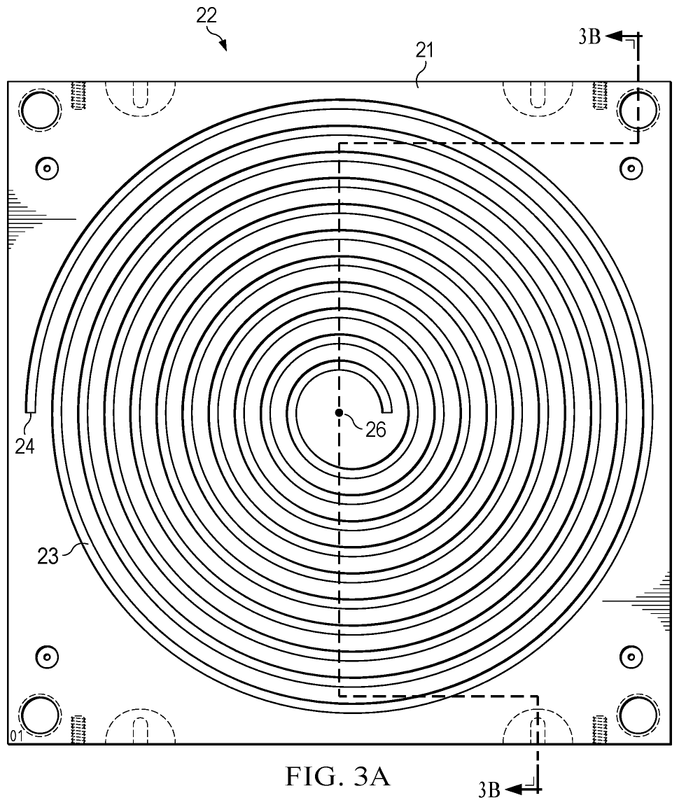

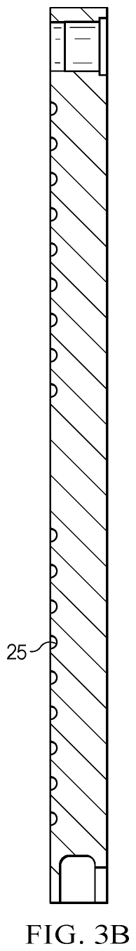

FIG. 3A is a top, plan view of an actual bottom mold plate 22 used in the practice of the invention. The mold plate has an exposed top surface 21 having the spiral pattern 23 formed therein. The spiral depressions are shown in the side cross-sectional view of FIG. 3B as 25. The bottom mold plate 22 would be used with a mating top mold plate (not shown). When the top and bottom plates are closed, a continuous spiral mold cavity is formed between the two halves of the mold.

As will be explained, a pair of mold plates will be used in the method of the invention to produce a long but relatively thin molded rubber product such as an elongated article arranged in a spiral configuration. The mold plates which are shown in the drawings would be fixed to upper and lower platens (not shown), one of which is fixed, the other being movable relative thereto, as in a conventional molding apparatus. The series of recessed areas or grooves 23 extend radially inward on the upper surface of the lower mold plate and provide a series of recessed areas forming the spiral pattern which will later produce the lower half of the product being molded. This pattern of recessed areas terminates at the edge of the exposed upper surface at an end region 24 that is spaced radially from a central hub 26 of the lower mold plate. The surface of the upper mold plate is provided with a spiral pattern that matches that of the lower mold plate to form the spiral configuration of an elongated article having a desired cross section.

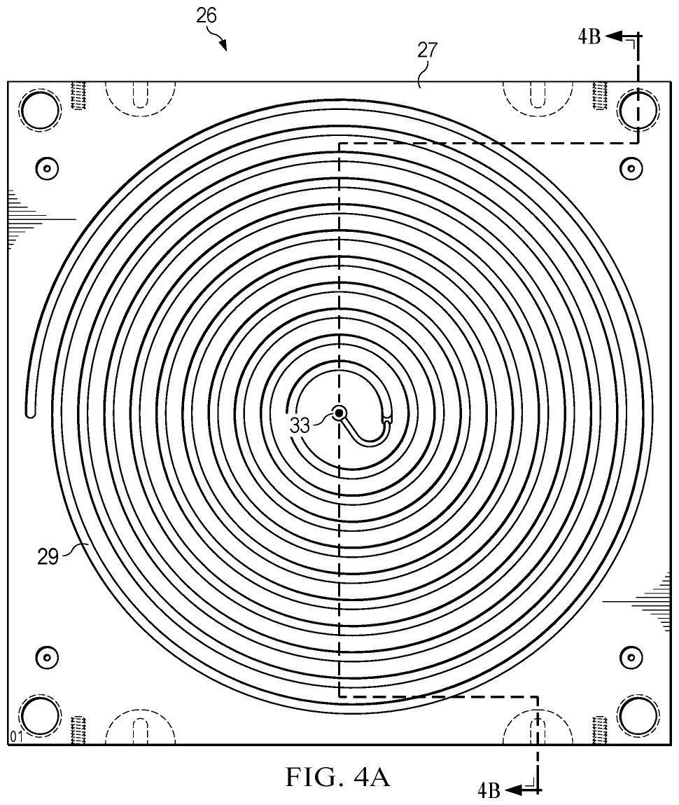

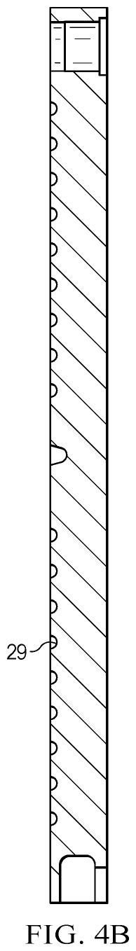

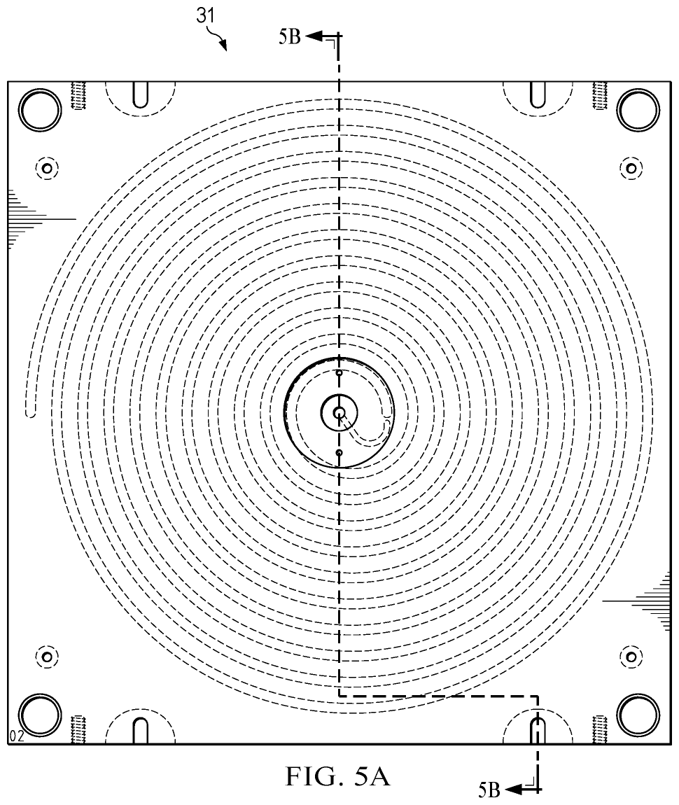

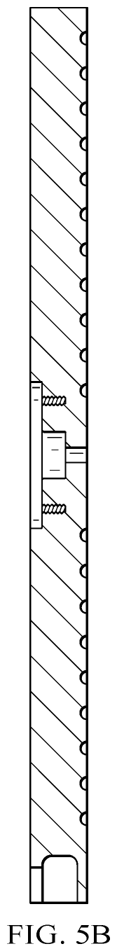

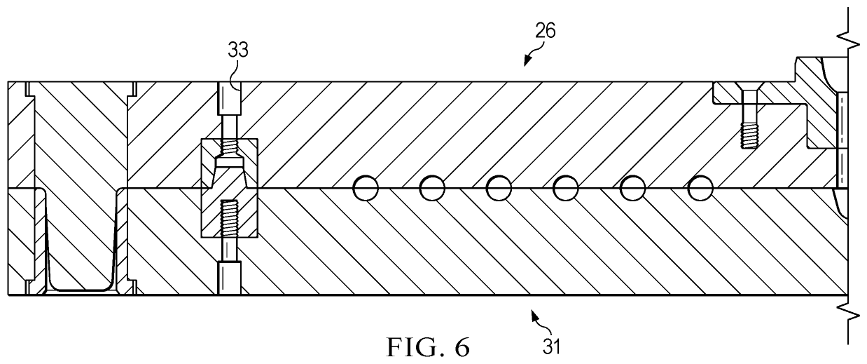

FIGS. 4A and 4B are similar views to FIGS. 3A and 3B, with the bottom mold plate 26 in FIG. 4A again having an exposed upper surface 27 having a continuous spiral shape 29 formed therein, the spiral grooves being indicated at 29 in FIG. 4B. The mating top mold plate 31 is shown in FIG. 4B. The top and bottom mold plates shown in FIGS. 4A and 5A differ from the bottom plate 22 in FIG. 3A in that these mold plates are provided with an injection gate (shown generally at 33 in FIG. 4A). The gate 33 can also be seen in cross-section in the view of FIG. 6. As will be explained more fully, the injection gate can be used to inject uncured elastomer into the spiral mold cavity in one version of the method of the invention.

In the first form of the method of the invention, the mold halves are initially in a spaced apart position. A ring of previously extruded, uncured “green” rubber is then placed in the spiral form 6 of the lower mold plate (such as plate 22 in FIG. 3A). The pre-extruded rubber in the near final form of the spiral cavity is laid in the spiral cavity to fill the cavity. In the case of a simple O-ring, the final gasket produced will be round and larger than the inner-most spiral, so that when it is spliced in the last step in the manufacturing process, it will tend to stay round.

The mold halves are then closed to compress the spiral and begin curing. This generally avoids excess flash and eliminates perpendicular movement of the elastomer. The closing of the upper and lower mold halves and the force applied to the mold plates may be varied to reduce any excess flash which would tend to produce a web between each spiral groove. When the mold halves are completely closed together, all of the cavities forming the spiral pattern in the mold surfaces are filled. The mold plates are held together while the rubber between them is cured as it is subjected to a preselected temperature and pressure. The exact temperature and pressure may vary according to the type of rubber compound used and the results desired and will be within the skill of one skilled in the relevant arts. Once the product within the mold has been properly cured, the mold halves are readily separated to remove the spiral gasket product.

Thus, the method of the invention in its first, simplest form theu involves the steps of:
providing mating upper and lower mold plates each having upper and lower exposed mold surfaces, the exposed mold surfaces being in the form of a continuous spiral groove or recess, the exposed surfaces registering to form a mold cavity shaped as a spiral coil of an elongated shape having a predetermined cross-section when he mold halves are closed;
providing a length of pre-extruded elastomeric material in the shape of the near final form of the spiral mold cavity;
laying the pre-extruded material into the lower mold cavity to substantially fill the cavity;
closing the upper and lower mold plates to compress the elastomeric material within the spiral cavities and thereafter curing the elastomeric material to form a spiral strip;
removing the spiral strip from the mold and trimming any flashing which may have been formed;
cutting the spiral strip into given lengths having opposing free ends;
splicing the free ends to form completed sealing gaskets.

The gasket material that is produced by the method of the invention forms a long product comprising a spirally wound, elongated article of generally uniform cross section. An unusually smooth and solid product results whose tolerances can be held to very close values. In some cases, the elongated spiral is held together by a small web between each coil in the spiral. The web can be easily cut to facilitate unwinding and removal of elastomer material in its elongated form when gaskets or the like are to be made from the material. The gasket material can then be cut to the desired length for the intended gasket application and the ends spliced using CA, epoxy or other extrusion splicing technologies. In this way, an adjustable length gasket can be provided in rolls that could be, for example, more than 15 meters long.

Because the uncured elastomeric material is initially laid in the mold cavity by hand, it can have hardened gripping elements, such as the elements shown at 15 in FIG. 1 placed at spaced intervals along the length of the uncured material. The hardened gripping elements may have a lower exposed surface with gripping “teeth” formed therein to grip the exterior surface of a male spigot pipe end being inserted into the mouth opening of the coupling 11. The gripping elements may be made of a metal, such as stainless steel, or other materials, including hardened plastics.

The first form of the inventive method also offers the advantage that materials can be used that might be difficult of impossible to extrude using normal extrusion techniques. For example, nitriles, neoprenes and other compounds that could not be made in a normal extruder with microwave oven curing such as peroxide cured compounds, NBR, and other elastomeric type materials.

The mold plates shown in FIGS. 4A and 5A differ from the first described mold plates because of the presence of the injection gate 33. In this form of the method of the invention, instead of pre-extruding gasket material and laying the gasket material in the spiral mold cavity, green rubber is extruded into the spiral mold cavity of the closed mold halves through the gate 33 to fill the mold cavity. Gaskets have been produced in this way, by closing the spiral mold and injecting a complete spiral of 15 meters in length through a single gate, curing the rubber and then cutting it to the desired size which is needed for splicing.

An invention as been provided with several advantages. The method of the invention allows gaskets of various sizes to be made using a single mold, eliminating the need for different size molds for different sized gaskets. Because a molding technique is used, the resulting gasket material may be of more uniform size and with tighter tolerances than with prior art extrusion techniques. The technique also lends itself to various modification which can be envisioned by those skilled in the relevant molding arts, including, for example:
Forming a gasket as a flat spiral where the spiral spreads radially;
Forming a cylindrical helicoid/helical spiral where the spiral extends axially, like a corkscrew;
Forming a conical hybrid, helical/spiral where the spiral extends axially and radially.

The spiral windings might be separated from each other by a greater or lesser distance, or the spirals might be next to each other, to reduce waste and pack more material into the same space. The gasket profile might be solid or perhaps even hollow in some circumstances.

The curing action could be after molding or curing can take place in the mold, as has been described.

While the invention has been shown in several of its forms, it is not thus limited but is susceptible to various changes and modifications without departing from the spirit thereof.

What is claimed is:

1. A method of manufacturing a sealing gasket for use in a pipe sealing system, the method comprising the steps of:
providing mating upper and lower mold plates each having upper and lower exposed mold surfaces, the exposed mold surfaces being in the form of a continuous spiral groove or recess, the exposed surfaces registering to form a mold cavity shaped as a spiral coil of an elongated shape having a predetermined cross-section when he mold halves are closed;
providing a length of pre-extruded elastomeric material in the shape of the near final form of the spiral mold cavity;
laying the pre-extruded material into the lower mold cavity to substantially fill the cavity;
closing the upper and lower mold plates to compress the elastomeric material within the spiral cavities and thereafter curing the elastomeric material to form a spiral strip;
removing the spiral strip from the mold and trimming any flashing which may have been formed;
cutting the spiral strip into given lengths having opposing free ends;
splicing the free ends to form completed sealing gaskets.

2. The method of claim 1, wherein the pre-extruded elastomeric material which is used has a shape selected from among the group consisting of:
a flat spiral where the spiral spreads radially in the mold cavity, a cylindrical helicoid/helical where the spiral extends axially like a corkscrew, and a conical hybrid, helical/spiral where the spiral extends axially and radially.

3. The method of claim 2, wherein the opposing free ends of the gasket material are spliced together using a suitable adhesive, epoxy, or other extrusion splicing technology.

4. The method of claim 3, wherein the continuous spiral of gasket material is 15 meters or longer in length before being cut.

5. A method of manufacturing a sealing gasket for use in a pipe sealing system, the method comprising the steps of:
providing mating upper and lower mold plates each having upper and lower exposed mold surfaces, the exposed mold surfaces being in the form of a continuous spiral groove or recess, the exposed surfaces registering to form a mold cavity shaped as a spiral coil of an elongated shape having a predetermined cross-section when he mold halves are closed;
closing the upper and lower mold plates and injecting a quantity of uncured elastomeric material through a gate provided in the mold plates and into the spiral cavity to substantially fill the mold cavity between the upper and lower mold plate to form a complete spiral of elastomeric material;
holding the mold plates together for a time and temperature sufficient to cure any uncured elastomeric material, any excess flash produced forming a web between the spiral cavities;
removing the spiral-shaped elastomeric material so formed and trimming any remaining web material;
cutting the elastomeric material to a desired length having two free ends;
splicing the free ends to thereby produce a completed sealing gasket.

6. The method of claim 5, wherein the spiral-shaped elastomeric material which is injected through the gate into the mold cavity is 15 meters or longer.

7. A method of manufacturing a sealing and restraint gasket for use in a restrained pipe sealing system, the method comprising the steps of:
providing mating upper and lower mold plates each having upper and lower exposed mold surfaces, the exposed mold surfaces being in the form of a continuous spiral groove or recess, the exposed surfaces registering to form a mold cavity shaped as a spiral coil of an elongated shape having a predetermined cross-section when he mold halves are closed;
placing a length of partially or fully cured elastomeric material into the spiral cavity of the lower mold plate, the elastomeric material having a series of discrete hardened gripping elements incorporated into the elestomeric material along the length of the elastomeric material;
bringing the upper mold plate in to contact with the lower mold plate to thereby enclose the elastomeric material into a spiral mold cavity formed between the two mold plates, the elastomeric material being forced to substantially fill the spiral cavity formed between the exposed surfaces of the mold plates, any excess flash produced forming a web between the spiral cavities;
holding the mold plates closed at a desired temperature for a desired time to fully cure the elastomeric material having the hardened gripping elements incorporated therein;
removing the spiral-shaped elastomeric material so formed and trimming any remaining web material;
cutting the elastomeric material to a desired length having two free ends;
splicing the free ends to thereby produce a completed retrained sealing gasket.

8. The method of claim 7, wherein the hardened gripping elements are made of metal or a hardened plastic material.
